(19) United States
(12) Patent Application Publication
(10) Pub. No.: US 2025/0202082 A1
(43) Pub. Date: Jun. 19, 2025

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuya IKEDA, Osaka (JP); Osamu NAKAYAMA, Osaka (JP); Ryota IKEDA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/844,663

(22) PCT Filed: Feb. 27, 2023
(86) PCT No.: PCT/JP2023/007003

§ 371 Date: Sep. 6, 2024

(30) Foreign Application Priority Data
Mar. 16, 2022 (JP) 2022-041301

(51) Int. Cl. H01M 50/583; H01M 50/249; H01M 50/298; H01M 50/505; H01M 50/519

(52) U.S. Cl. CPC H01M 50/583; H01M 50/249; H01M 50/298; H01M 50/505; H01M 50/519

(57) ABSTRACT

A wiring module to be attached to a plurality of power storage devices, including a busbar to be connected to electrode terminals of the plurality of power storage devices, a flexible board, a metal piece connecting the busbar to the flexible board, and an electric wire, in which the flexible board has formed thereon a conductive path having a first land connected to the metal piece, a second land connected to the electric wire, and a fuse portion provided between the first land and the second land, and the flexible board includes a board body and a coupling portion coupling the board body to the metal piece while allowing displacement of the metal piece relative to the board body.

### TECHNICAL FIELD

The present disclosure relates to a wiring module.

### BACKGROUND ART

High-voltage battery packs used in electric vehicles, hybrid vehicles, and the like typically have a large number of stacked battery cells that are electrically connected in series or parallel by a wiring module. Conventionally, a known example of such a wiring module is a busbar assembly described in JP 2019-500736A (Patent Document 1 below). The busbar assembly described in Patent Document 1 is attached to a plurality of battery cells that have electrode leads protruding on at least one side thereof and are stacked on each other, and is constituted to include a busbar frame provided with lead slots through which the electrode leads are passed, and a busbar electrically coupling the electrode leads that pass through the lead slots.

### CITATION LIST

### Patent Documents

Patent Document 1: JP 2019-500736A

### SUMMARY OF INVENTION

### Technical Problem

In the above configuration, the busbar assembly does not have a fuse function. In order to provide the wiring module with a fuse function, it is conceivable to incorporate a circuit board that includes a fuse into the wiring module. However, use of the circuit board may increase the manufacturing costs of the wiring module.

Further, temperature changes that occur during vehicle use cause the battery cells to expand or contract. This may damage the circuit board mainly at the connection portion between the busbar and the circuit board, and impair the electrical connection between the busbar and the circuit board.

### Solution to Problem

A wiring module of the present disclosure is a wiring module to be attached to a plurality of power storage devices, and includes a busbar to be connected to electrode terminals of the plurality of power storage devices, a flexible board, a metal piece connecting the busbar to the flexible board, and an electric wire, in which the flexible board has formed thereon a conductive path having a first land connected to the metal piece, a second land connected to the electric wire, and a fuse portion provided between the first land and the second land, and the flexible board includes a board body and a coupling portion coupling the board body to the metal piece while allowing displacement of the metal piece relative to the board body.

### Advantageous Effects of Invention

According to the present disclosure, a wiring module that is able to suppress an increase in manufacturing costs incurred in providing a fuse function and to suppress damage to a flexible board can be provided.

### BRIEF DESCRIPTION OF DRAWINGS

FIG. 1 is a schematic view illustrating a vehicle equipped with a power storage module according to a first embodiment.

FIG. 2 is a plan view of the power storage module.

FIG. 3 is a partially enlarged plan view of the power storage module illustrating the periphery of a flexible board.

FIG. 4 is a plan view illustrating the flexible board.

FIG. 5 is a schematic sectional view taken along line A-A of FIG. 4.

FIG. 6 is a perspective view illustrating a coupling portion.

FIG. 7 is a partially enlarged plan view of the power storage module illustrating the periphery of a flexible board according to a second embodiment.

FIG. 8 is a partially enlarged view of the power storage module illustrating a fuse portion of the flexible board according to a third embodiment.

### DESCRIPTION OF EMBODIMENTS

### Description of Embodiments of the Present Disclosure

First, embodiments of the present disclosure will be listed and described.
(1) A wiring module of the present disclosure is a wiring module to be attached to a plurality of power storage devices, and includes a busbar to be connected to electrode terminals of the plurality of power storage devices, a flexible board, a metal piece connecting the busbar to the flexible board, and an electric wire, in which the flexible board has formed thereon a conductive path having a first land connected to the metal piece, a second land connected to the electric wire, and a fuse portion provided between the first land and the second land, and the flexible board includes a board body and a coupling portion coupling the board body to the metal piece while allowing displacement of the metal piece relative to the board body.

With such a configuration, the wiring module is provided with the electric wire in addition to the flexible board, and thus use of the flexible board can be reduced compared to when the electric wire is not provided. Therefore, the manufacturing costs of the wiring module can be reduced.

Further, displacement of the metal piece relative to the board body can be allowed by the coupling portion. Therefore, even when the power storage devices expand or contract due to a temperature change, or when an external force is applied to the wiring module and the busbar is deformed, the flexible board is less likely to be damaged, and an electrical connection between the busbar and the flexible board can be maintained.
(2) The coupling portion is preferably expandable and contractible.

With such a configuration, the coupling portion expands and contracts, and thus it is easier to allow displacement of the metal piece relative to the board body.
(3) The coupling portion preferably extends from the board body and has a wire spring shape including at least one curved portion.

With such a configuration, it is possible to allow displacement of the metal piece relative to the board body with a simple configuration.
(4) The flexible board preferably includes a reinforcing plate attached to a region of the board body including the second land.

With such a configuration, the reinforcing plate can reinforce a connection portion between the second land and the electric wire in the board body.
(5) A plurality of the conductive paths are preferably formed on at least one of the flexible board.

With such a configuration, the number of the flexible boards used in the wiring module can be reduced, and thus the ease of assembly of the wiring module can be improved.

(6) The fuse portion is preferably constituted by a chip fuse connected to
the conductive path by solder.

With such a configuration, the conductive path can be protected from overcurrent, due to the chip fuse melting when overcurrent flows through the conductive path.
(7) The fuse portion is preferably constituted by a pattern fuse.

With such a configuration, the fuse portion can be formed in a manufacturing process of the flexible board.
(8) The above wiring module is a vehicle wiring module to be electrically attached to the plurality of power storage devices installed in a vehicle.

### Details of Embodiments of the Present Disclosure

Embodiments of the present disclosure will be described below. The present disclosure is not limited to these illustrative examples and is defined by the claims, and all changes that come within the meaning and range of equivalency of the claims are intended to be embraced therein.

### First Embodiment

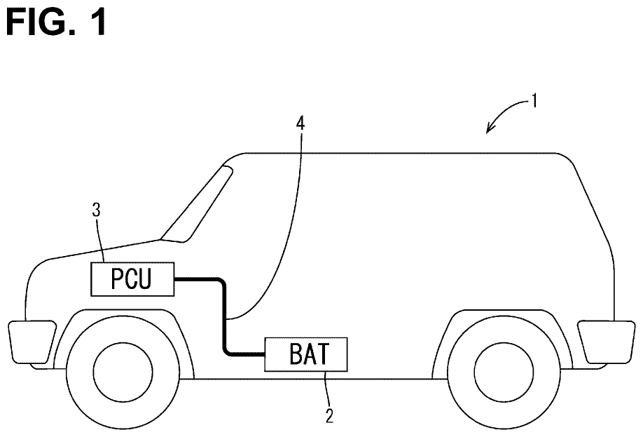

A first embodiment of the present disclosure will be described with reference to FIGS. 1 to 6. A power storage module 10 that includes a wiring module 20 of the present embodiment is, for example, applied to a power storage pack 2 installed in a vehicle 1, as illustrated in FIG. 1. The power storage pack 2 is installed in the vehicle 1, which is an electric vehicle, a hybrid vehicle, or the like, and used as a drive source for the vehicle 1. In the following description, only some of a plurality of identical members may be denoted by reference numerals, and the reference numerals for the other members may be omitted.

As illustrated in FIG. 1, the power storage pack 2 is provided near the center of the vehicle 1. A power control unit (PCU) 3 is provided in a front part of the vehicle 1. The power storage pack 2 and the PCU 3 are connected by a wire harness 4. The power storage pack 2 and the wire harness 4 are connected by a connector (not illustrated). The power storage pack 2 has the power storage module 10 including a plurality of power storage devices 11. The power storage module 10 (and the wiring module 20) can be installed in the vehicle in any orientation, and in the following description, except for FIG. 1, a direction indicated by an arrow Z is an upward direction, a direction indicated by an arrow X is a forward direction, and a direction indicated by an arrow Y is a leftward direction.

### [Power Storage Devices, Electrode Terminals]

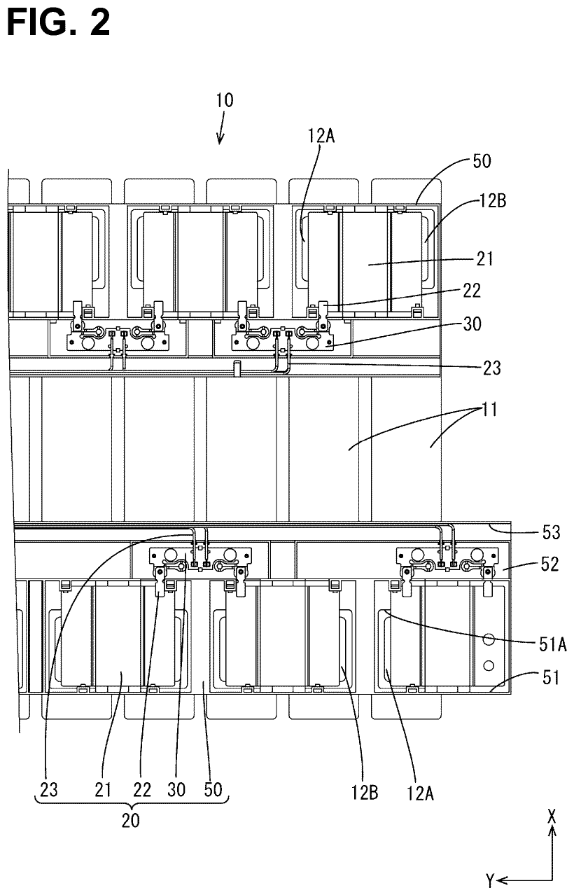

As illustrated in FIG. 2, the power storage module 10 includes the plurality of power storage devices 11 arranged in a row in a left-right direction, and the wiring module 20 attached to upper surfaces of the plurality of power storage devices 11 (left side portion of the power storage module 10 is not illustrated). The power storage devices 11 each have a flattened rectangular parallelepiped shape. A power storage element (not illustrated) is housed inside the power storage device 11. The power storage device 11 has positive and negative electrode terminals 12A and 12B on the upper surface thereof. The power storage device 11 is not particularly limited and may be a secondary battery or a capacitor. The power storage device 11 according to the present embodiment is a secondary battery.

### [Wiring Module]

The wiring module 20 includes a busbar 21 connected to the electrode terminals 12A and 12B, a flexible board 30, a metal piece 22 connecting the busbar 21 to the flexible board 30, an electric wire 23 connected to the flexible board 30, and a protector 50 that holds the busbar 21, the flexible board 30, the metal piece 22, and the electric wire 23. The wiring module 20 is attached to the front side and rear side of the plurality of power storage devices 11. A configuration of the wiring module 20 disposed on the rear side will be described in detail below. Note that the wiring module 20 disposed on the front side is inverted in both the front-rear direction and the left-right direction, but otherwise there is no difference between the configuration of the wiring module 20 disposed on the front side and the configuration of the wiring module 20 disposed on the rear side.

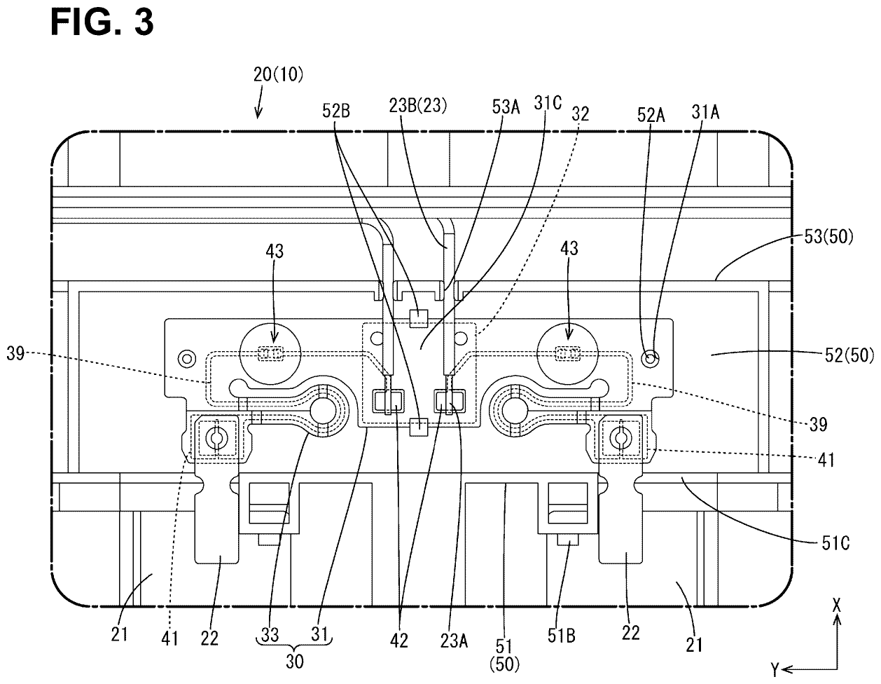

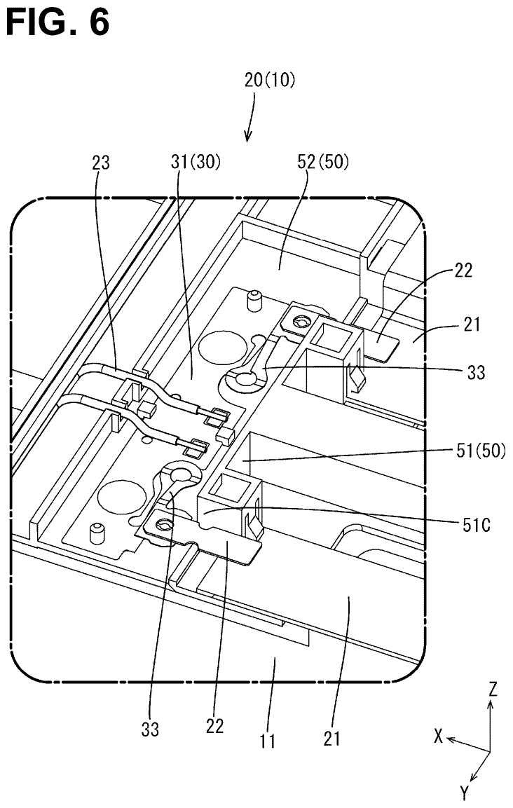

The protectors 50 is made of an insulating synthetic resin and has a plate shape. The protector 50 includes a busbar housing portion 51 housing the busbar 21, a board holding portion 52 holding the flexible board 30, and an electric wire routing portion 53 in which the electric wire 23 is routed. The busbar housing portion 51 has a frame shape. A connection hole 51A for connecting the electrode terminals 12A and 12B to the busbar 21 is formed in a lower part of the busbar housing portion 51. As illustrated in FIG. 3, a locking portion 51B for holding the busbar 21 within the busbar housing portion 51 is provided on a peripheral wall of the busbar housing portion 51. As illustrated in FIG. 6, a side wall of the busbar housing portion 51 has a recess 51C that is partially recessed downward. The metal piece 22 that connects the busbar 21 to the flexible board 30 is disposed in the recess 51C.

As illustrated in FIG. 3, the electric wire routing portion 53 has a groove shape extending in the left-right direction. The board holding portion 52 is disposed between the busbar housing portion 51 and the electric wire routing portion 53. An electric wire insertion portion 53A is formed in a recessed shape in a groove wall on the board holding portion 52 side of the electric wire routing portion 53. The electric wire 23 inserted into the electric wire insertion portion 53A is connected to the flexible board 30. The board holding portion 52 includes protrusions 52A that are inserted into fixing holes 31A of the flexible board 30, and locking claws 52B that lock a center portion of the flexible board 30 in the left-right direction.

### [Busbars]

The busbars 21 are each made of a metal plate material having conductivity. Examples of metals constituting the busbar 21 include copper, a copper alloy, aluminum, an aluminum alloy, and stainless steel (SUS). As illustrated in FIG. 2, the busbar 21 is rectangular in plan view. The busbar 21 and the electrode terminals 12A and 12B are electrically connected by welding. There are busbars 21 that connect the electrode terminals 12A and 12B of adjacent power storage devices 11, and busbars 21 that are connected to all the positive electrodes or all the negative electrodes of the plurality of power storage devices 11, but no particular distinction therebetween will be made below.

### [Metal Pieces]

The metal pieces 22 are each constituted by a metal having conductivity. Examples of metals constituting the metal piece 22 include nickel, copper, a copper alloy, aluminum, and an aluminum alloy. As illustrated in FIG. 3, the metal piece 22 has a long shape in the front-rear direction. One end portion (rear end portion in FIG. 3) of the metal piece 22 is connected to the busbar 21. In the present embodiment, the metal piece 22 and the busbar 21 are connected by welding. The other end portion (front end portion in FIG. 3) of the metal piece 22 is connected to the flexible board 30. In the present embodiment, the metal piece 22 and the flexible board 30 are connected by soldering.

### [Electric Wires]

As illustrated in FIG. 3, the electric wires 23 each have a core wire 23A and an insulating coating 23B that covers the core wire 23A. The core wire 23A exposed at one end of the electric wire 23 is connected to a second land 42 by soldering. The insulating coating 23B at the one end of the electric wire 23 is inserted into the electric wire insertion portion 53A and fixed. Although not illustrated, the other end of the electric wire 23 is connected to an external electronic control unit (ECU) or the like via a connector. The ECU is equipped with a microcomputer, devices, and the like, and has a well-known configuration including functions such as detecting voltage, current, temperature, and the like of each power storage device 11 and controlling charging and discharging of each power storage device 11.

### [Flexible Board]

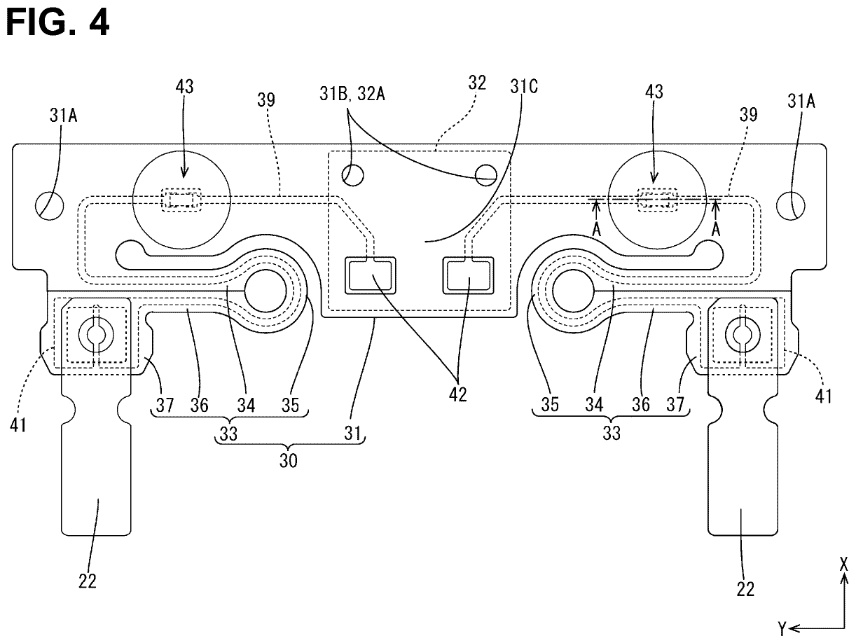

The flexible board 30 is a circuit board having flexibility, and, in the present embodiment, is a flexible printed board. As illustrated in FIG. 4, the flexible board 30 is long in the left right direction and is bilaterally symmetrical. The flexible board 30 includes a board body 31 and a coupling portion 33 coupling the board body 31 to the metal piece 22. The board body 31 has the fixing holes 31A and positioning holes 31B that pass through in an up-down direction. One fixing hole 31A is provided at each of left and right end portions of the board body 31. Two positioning holes 31B are provided at positions near a center portion in the left-right direction. When attaching a reinforcing plate 32 to the flexible board 30, the flexible board 30 and the reinforcing plate 32 are positioned by inserting positioning pins (not illustrated) into the positioning holes 31B and a through-hole 32A provided in the reinforcing plate 32. As illustrated in FIG. 3, since the projections 52A of the protector 50 are inserted into the fixing holes 31A, movement of the board body 31 relative to the protector 50 in the left-right and front-rear directions is restricted.

Further, the protrusions 52A may also be provided at positions corresponding to the positioning hole 31B and the through-hole 32A, and the protrusions 52A may be inserted into the positioning hole 31B and the through-hole 32A. The protrusions 52A may be provided at positions contacting the electric wires 23, and the direction in which the electric wires 23 are lead out may be regulated by the protrusions 52A.

### [Reinforcing Plate]

As illustrated in FIG. 4, the reinforcing plate 32 is attached to a lower surface of the center portion of the board body 31 in the left-right direction. In the present embodiment, the reinforcing plate 32 is an insulating member. For example, the reinforcing plate 32 is formed by an epoxy resin being impregnated into a fiberglass cloth and cured. Further, different from the present embodiment, the reinforcing plate may be a metal plate, such as an aluminum plate, for example. The region in the center portion of the board body 31 reinforced by the reinforcing plate 32 in the left-right direction is a reinforced portion 31C. As illustrated in FIG. 3, the second lands 42 connected to the electric wires 23 are arranged on the reinforced portion 31C. The reinforced portion 31C and the reinforcing plate 32 are locked from above by the locking claws 52B of the protector 50. In this way, the reinforcing plate 32 can also be used to hold the board body 31 against the protector 50.

### [Coupling Portions, Curved Portions]

The coupling portions 33 are each configured to be displaceable to a certain degree in the front-rear, left-right, and up-down directions. As illustrated in FIG. 4, the coupling portion 33 of the present embodiment includes a first straight portion 34 extending from the board body 31 in the left-right direction, a curved portion 35 curved in a substantially U-shape at an extending end of the first straight portion 34, a second straight portion 36 extending from an extending end of the curved portion 35 in the left-right direction, and a connecting end portion 37 formed at an extending end of the second straight portion 36 and connected to the metal piece 22. That is, the coupling portion 33 is configured to have a wire spring shape as a whole. The coupling portion 33 is thereby expandable and contractible in the front-rear, left-right, and up-down directions. Since the curved portion 35 that curves back on itself is disposed between the first straight portion 34 and the second straight portion 36, the first straight portion 34 and the second straight portion 36 are arranged in parallel in the front-rear direction in plan view. In the present embodiment, a pair of left and right coupling portions 33 are provided on one flexible board 30.

FIG. 6 is a diagram illustrating the configuration around the coupling portions 33, with some of the configuration being omitted in FIG. 6 to make the coupling portions 33 easier to see. As illustrated in FIG. 6, in the wiring module 20, the metal pieces 22 connected to the busbars 21 are coupled, via the coupling portions 33, to the board body 31 held by the protector 50. Due to the coupling portions 33 expanding and contracting, the busbars 21 (and the metal pieces 22) are configured to be displaceable to a certain extent in all of the arrangement direction of the busbars 21 (left-right direction), the direction in which the busbars 21 move away from or toward the board body 31 (front-rear direction), and the thickness direction of the board body 31 (up-down direction). Therefore, even when the temperature changes due to use of the vehicle 1 in which the power storage module 10 is installed, and the power storage devices 11 (and the busbars 21) expand or contract, the coupling portions 33 expand and contract, and thus a connection portion between the flexible board 30 and the metal pieces 22 is unlikely to be damaged, and the electrical connection between the busbars 21 and the flexible board 30 via the metal pieces 22 is easily maintained.

### [Conductive Path]

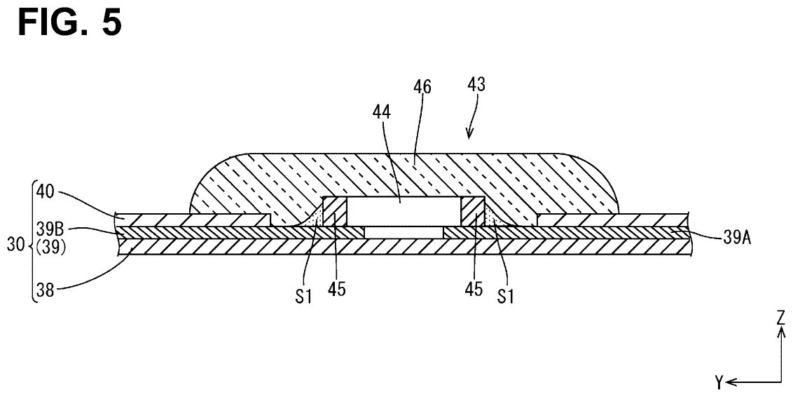

As illustrated in FIG. 5, the flexible board 30 includes a base film 38, a conductive path 39 routed on a surface of the base film 38, and a coverlay film 40 that covers the conductive path 39. The base film 38 and the coverlay film 40 are made of a synthetic resin such as polyimide that has insulating properties and flexibility. The conductive path 39 is constituted by a metal foil made of copper, a copper alloy, or the like. As illustrated in FIG. 3, the flexible board 30 of the present embodiment includes two separate conductive paths 39 that are not electrically connected to each other. One conductive path 39 is constituted to include a first land 41 connected to the metal piece 22, a second land 42 connected to the electric wire 23, and a fuse portion 43 provided between the first land 41 and the second land 42.

### [First Lands, Second Lands]

As illustrated in FIG. 4, the first land 41 is formed on the connecting end portion 37 of the coupling portion 33 and is disposed at one end of the conductive path 39. The second land 42 is formed on the reinforced portion 31C and is disposed at the other end of the conductive path 39. As illustrated in FIG. 3, the first land 41 is electrically connected to the busbar 21 via the metal piece 22. The second land 42 is connected to the core wire 23A of the electric wire 23 by soldering.

### [Fuse Portions]

As illustrated in FIG. 4, the fuse portions 43 are each provided on the conductive path 39 partway from the first land 41 to the second land 42. The fuse portion 43 is disposed on the board body 31. As illustrated in FIG. 5, the fuse portion 43 in the present embodiment has a chip fuse 44, and the chip fuse 44 and the conductive path 39 are connected by solder S1. Specifically, one of a pair of electrodes 45 of the chip fuse 44 is connected to a conductive path 39A on the first land 41 side, and the other of the pair is connected to a conductive path 39B on the second land 42 side.

Due to the fuse portions 43 being provided, even when a fault occurs in an external circuit to which the power storage module 10 is connected and the conductive paths 39 are short-circuited, resulting in overcurrent, flow of the overcurrent from the power storage devices 11 to the conductive paths 39 can be restricted, due to the chip fuses 44 melting.

As illustrated in FIG. 5, in the present embodiment, a connection portion between the chip fuse 44 and the conductive path 39 is covered by a sealing portion 46. Here, the connection portion between the chip fuse 44 and the conductive path 39 includes at least the entire chip fuse 44, the solder S1, and an end portion of the conductive path 39 connected to the electrodes 45 of the chip fuse 44, with the end portion not being covered by the coverlay film 40. The sealing portion 46 is constituted by a curable insulating resin. Since the sealing portion 46 covers the connection portion between the chip fuse 44 and the conductive path 39, it is possible to suppress short-circuiting of the conductive paths 39 even when water droplets or the like are formed on the flexible board 30 due to condensation.

In the present embodiment, as illustrated in FIG. 4, the flexible board 30 is formed with the absolute minimum dimensions required to form the first lands 41, the fuse portions 43, and the second lands 42. Further, as illustrated in FIG. 3, inexpensive electric wires 23 are used as conductors to connect the flexible board 30 to connectors (not illustrated) on the ECU side. Accordingly, it is possible to suppress an increase in the manufacturing costs of the wiring module 20 incurred in providing the fuse function.

The wiring module 20 of the present embodiment includes the flexible board 30 that is constituted to include two conductive paths 39. The number of flexible boards 30 in the wiring module 20 to be reduced, compared to when only one conductive path 39 is formed on one flexible board 30, and thus the efficiency of the work of placing the flexible boards 30 on the protector 50 can be improved.

As illustrated in FIG. 3, in the flexible board 30, two first lands 41 are arranged one on each of both left and right sides of the flexible board 30, and two second lands 42 are arranged at intermediate positions in the left-right direction between the two first lands 41. With such a configuration, it is easy to place the flexible board 30 at an intermediate position in the left-right direction between two adjacent busbars 21. In addition, it is easy to miniaturize the flexible board 30 to match an interval between the busbars 21 in the left-right direction.

### [Method for Manufacturing Wiring Module]

The configuration of the wiring module 20 is as described above, and one example of a method for manufacturing the wiring module 20 will be described below.

First, the flexible board 30 is manufactured using a printed wiring technology. The coupling portion 33 is formed by making cuts in an individual piece of the flexible board 30 that has been punched. The reinforcing plate 32 is attached to the flexible board 30 with an adhesive or the like. The chip fuse 44 and the metal piece 22 are soldered to the flexible board 30 by reflow.

Next, the sealing portion 46 that seals the chip fuse 44 is formed. A liquid insulating resin before curing is dropped onto the connection portion between the chip fuse 44 and the conductive path 39 on the flexible board 30 using a dispenser or the like and applied in a dome shape. The applied insulating resin is cured by a known technique. Any method can be appropriately selected as a method for curing the insulating resin, such as cooling, mixing a curing agent, or light irradiation.

The busbar 21 is housed in the busbar housing portion 51 of the protector 50. The busbar 21 is held in the busbar housing portion 51 by the locking portion 51B. Next, the flexible board 30 is disposed on the board holding portion 52 of the protector 50. The protrusions 52A are inserted into the fixing holes 31A, and the reinforced portion 31C and the reinforcing plate 32 are locked by the locking claws 52B. The lower surface of the metal piece 22 is brought into contact with the upper surface of the busbar 21 and welded.

The electric wire 23 is routed in the electric wire routing portion 53, and the end portion of the electric wire 23 at which the core wire 23A is exposed is inserted into the electric wire insertion portion 53A. The core wire 23A of the electric wire 23 is connected to the second land 42 by soldering. This completes manufacturing of the wiring module 20.

Note that the above is an example of the method for manufacturing the wiring module 20, and the order of the steps may be changed. For example, the electric wire 23 may be soldered in the step of soldering the chip fuse 44 or the like to the flexible board 30. Further, the busbar 21 may be welded to the electrode terminals 12A and 12B, and thereafter the busbar 21 and the metal piece 22 may be welded together.

### Operation and Effect of First Embodiment

The first embodiment achieves the following operation and effect.

The wiring module 20 according to the first embodiment is a wiring module 20 to be attached to a plurality of power storage devices 11, and includes a busbar 21 to be connected to electrode terminals 12A and 12B of the plurality of power storage devices 11, a flexible board 30, a metal piece 22 connecting the busbar 21 to the flexible board 30, and an electric wire 23, in which the flexible board 30 has formed thereon a conductive path 39 having a first land 41 connected to the metal piece 22, a second land 42 connected to the electric wire 23, and a fuse portion 43 provided between the first land 41 and the second land 42, and the flexible board 30 includes a board body 31 and a coupling portion 33 coupling the board body 31 to the metal piece 22 while allowing displacement of the metal piece 22 relative to the board body 31.

With such a configuration, the wiring module 20 is provided with the electric wire 23 in addition to the flexible board 30, and thus use of the flexible board 30 can be reduced compared to when the electric wire 23 is not provided. Therefore, the manufacturing costs of the wiring module 20 can be reduced.

Further, the coupling portion 33 is able to allow displacement of the metal piece 22 relative to the board body 31. Therefore, even when the power storage device 11 expands or contracts due to a temperature change, or when an external force is applied to the wiring module 20 and the busbar 21 is deformed, the flexible board 30 is less likely to be damaged, and the electrical connection between the busbar 21 and the flexible board 30 can be maintained.

In the first embodiment, the coupling portion 33 is expandable and contractible.

With such a configuration, the coupling portion 33 expands and contracts, and thus it is easier to allow displacement of the metal piece 22 relative to the board body 31.

In the first embodiment, the coupling portion 33 extends from the board body 31 and has a wire spring shape that includes at least one curved portion 35.

With such a configuration, it is possible to allow displacement of the metal piece 22 relative to the board body 31 with a simple configuration.

In the first embodiment, the flexible board 30 includes a reinforcing plate 32 attached to a region of the board body 31 including the second land 42.

With such a configuration, the reinforcing plate 32 is able to reinforce the connection portion between the second land 42 and the electric wire 23 in the board body 31.

In the first embodiment, a plurality of (two) conductive paths 39 are formed on at least one of the flexible board 30.

With such a configuration, the number of flexible boards 30 used in the wiring module 20 can be reduced, and thus the ease of assembly of the wiring module 20 can be improved.

In the first embodiment, the fuse portion 43 includes a chip fuse 44 connected to the conductive path 39 by solder S1.

With such a configuration, the conductive path 39 can be protected from overcurrent, due to the chip fuse 44 melting when overcurrent flows through the conductive path 39.

The wiring module 20 according to the first embodiment is a vehicle wiring module 20 to be electrically attached to the plurality of power storage devices 11 installed in a vehicle 1.

### Second Embodiment

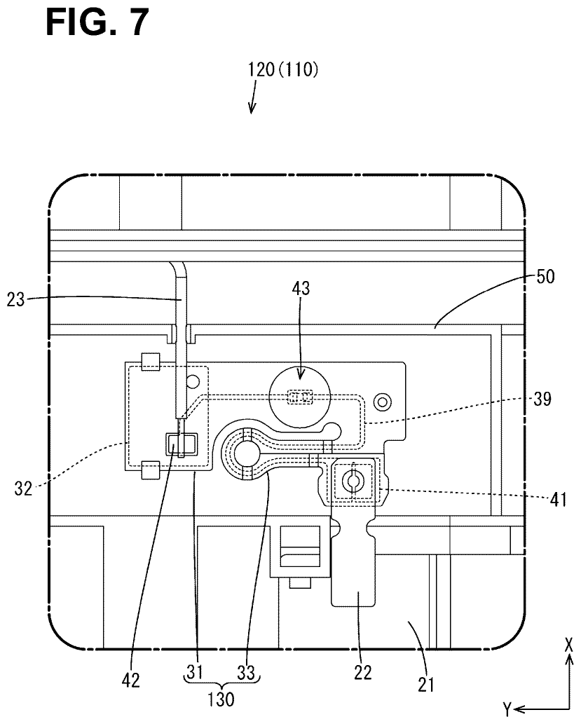

A second embodiment of the present disclosure will be described with reference to FIG. 7. The configuration of the second embodiment is the same as the configuration of the first embodiment, except that a flexible board 130 is provided. Hereinafter, the same members as the first embodiment will be given reference numerals used in the first embodiment, and description of configuration and operation and effect that are the same as in the first embodiment will be omitted.

A wiring module 120 (power storage module 110) in the second embodiment includes the flexible board 130. Only one conductive path 39 is formed on the flexible board 130. When such a flexible board 130 is used, it may be possible to eliminate an unnecessary conductive path 39 and miniaturize the flexible board 130, in cases such as where the flexible board 130 is disposed at an end portion of the wiring module 120 in the left-right direction, for example. Otherwise, the operation and effect are the same as the first embodiment, and description thereof will be omitted.

### Third Embodiment

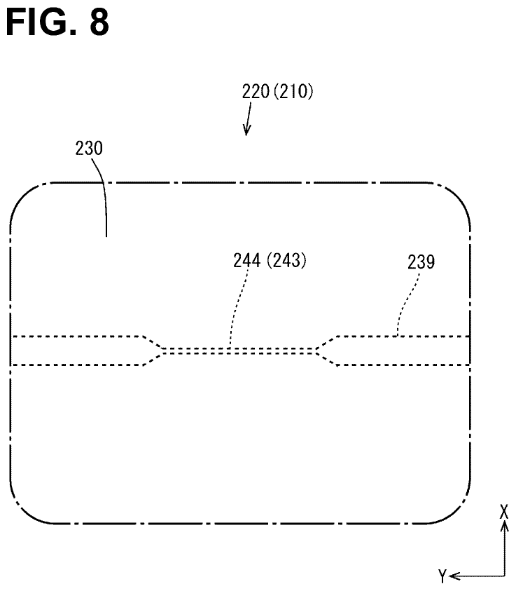

A third embodiment of the present disclosure will be described with reference to FIG. 8. A wiring module 220 (power storage module 210) of the third embodiment is constituted similarly to the first embodiment, except for a fuse portion 243 of a flexible board 230. Hereinafter, description of configuration and operation and effect that are the same as the first embodiment will be omitted, and only the fuse portion 243 of the flexible board 230 will be described.

As illustrated in FIG. 8, the flexible board 230 according to the third embodiment includes the fuse portion 243. The fuse portion 243 is constituted by a pattern fuse 244 provided by forming a thin conductive path 239. The pattern fuse 244, being thin, heats up and melts when overcurrent flows, and the flow of the overcurrent through the conductive path 239 can be limited.

In the present embodiment, the pattern fuse 244 (fuse portion 243) can be formed when forming the conductive path 239 in a normal manufacturing process of the flexible board 230. Accordingly, the step of forming the fuse portion 43 in the first embodiment, that is, the step of connecting the chip fuse 44 to the end portion of the conductive path 39 can be omitted.

### Operation and Effect of Third Embodiment

The third embodiment achieves the following operation and effect.

In the third embodiment, the fuse portion 243 is constituted by the pattern fuse 244.

With such a configuration, the fuse portion 243 can be constituted in the manufacturing process of the flexible board 230.

### OTHER EMBODIMENTS

(1) In the above embodiments, the coupling portion 33 has one curved portion 35, but the present disclosure is not limited thereto, and the coupling portion may include two or more curved portions.
(2) In the first embodiment, one flexible board 30 includes two conductive paths 39, and, in the second embodiment, one flexible board 130 includes one conductive path 39, but the present disclosure is not limited thereto, and one flexible board may include three or more conductive paths.
(3) In the first and second embodiments, the connection portion between the chip fuse 44 and the conductive path 39 is sealed with the sealing portion 46, but the present disclosure is not limited thereto, and a configuration in which the chip fuse is not sealed with a sealing portion may be adopted.
(4) In the above embodiments, the wiring modules 20, 120, and 220 include the protector 50, but the present disclosure is not limited thereto, and the wiring module may not include a protector.

### LIST OF REFERENCE NUMERALS

1 Vehicle
2 Power storage pack
3 PCU
4 Wire harness
10, 110, 210 Power storage module
11 Power storage device
12A, 12B Electrode terminal
20, 120, 220 Wiring module
21 Busbar
22 Metal piece
23 Electric wire
23A Core wire
23B Insulating coating
30, 130, 230 Flexible board
31 Board body
31A Fixing hole
31B Positioning hole
31C Reinforced portion
32 Reinforcing plate
32A Through-hole
33 Coupling portion
34 First straight portion
35 Curved portion
36 Second straight portion
37 Connecting end portion
38 Base film
39, 239 Conductive path
39A Conductive path on first land side
39B Conductive path on second land side
40 Coverlay film
41 First land
42 Second land
43, 243 Fuse portion
44 Chip fuse
45 Electrode
46 Sealing portion
50 Protector
51 Busbar housing portion
51A Connection hole
51B Locking portion
51C Recess
52 Board holding portion
52A Protrusion
52B Locking claw
53 Electric wire routing portion
53A Electric wire insertion portion
244 Pattern fuse
S1 Solder

1. A wiring module to be attached to a plurality of power storage devices, the wiring module comprising:
a busbar to be connected to electrode terminals of the plurality of power storage devices;
a flexible board;
a metal piece connecting the busbar to the flexible board; and
an electric wire, wherein
the flexible board has formed thereon a conductive path having a first land connected to the metal piece, a second land connected to the electric wire, and a fuse portion provided between the first land and the second land, and
the flexible board includes:
a board body; and
a coupling portion coupling the board body to the metal piece while allowing displacement of the metal piece relative to the board body.

2. The wiring module according to claim 1, wherein the coupling portion is expandable and contractible.

3. The wiring module according to claim 2, wherein the coupling portion extends from the board body and has a wire spring shape including at least one curved portion.

4. The wiring module according to claim 1, wherein the flexible board includes a reinforcing plate attached to a region of the board body including the second land.

5. The wiring module according to claim 1, wherein a plurality of the conductive paths are formed on the flexible board.

6. The wiring module according to claim 1, wherein the fuse portion is constituted by a chip fuse connected to the conductive path by solder.

7. The wiring module according to claim 1, wherein the fuse portion is constituted by a pattern fuse.

8. The wiring module according to claim 1 is a vehicle wiring module to be electrically attached to the plurality of power storage devices installed in a vehicle.
